(19) United States
(12) Patent Application Publication
(10) Pub. No.: US 2015/0019233 A1
(43) Pub. Date: Jan. 15, 2015

(54) SITE-SPECIFIC CLINICAL TRIAL PERFORMANCE METRIC SYSTEM

(71) Applicant: Forte Research Systems, Inc., Madison, WI (US)

(72) Inventor: Srini Kalluri, Madison, WI (US)

(21) Appl. No.: 13/939,023

(22) Filed: Jul. 10, 2013

(51) Int. Cl. G06Q 30/00; G06Q 50/22

(52) U.S. Cl. CPC G06Q 30/018; G06Q 50/22
USPC 705/2

(57) ABSTRACT

A computing device can receive site data from a plurality of sites within an industry. The site data can relate to the performance of the sites in at least one measurable metric. The computing device can determine an industry metric based on the site data received from the plurality of sites. The computing device can send the determined industry metric the plurality of sites.

### BACKGROUND

The following description is provided to assist the understanding of the reader. None of the information provided or references cited is admitted to be prior art.

One model of performing clinical trials includes a sponsor organization that works with various clinical research sites to conduct a clinical trial. The sponsor organization can be a pharmaceutical company, a government organization, an academic organization, a clinical researcher, or any others who sponsor clinical trials. The sponsor organization can provide each site with discrete and isolated work related to a project, or clinical trial after the site applies for such work. During and after the site performs work for the sponsor organization, the site can provide the sponsor organization with various information relating to the site's performance. Such information typically includes status reports, results of the clinical trial, or other information generated by the site for the purpose of informing or updating the sponsor organization on progress of a current clinical trial. The information shared with the sponsor is typically limited to necessary status updates related to the particular clinical trial. Thus, the sponsor organization only receives information related to a current project of the site. Under this model, the site typically does not receive feedback regarding the site's performance from the sponsor organization. In addition, when a site applies for work related to a clinical trial, the sponsor typically requests the past performance information from the sites. Any information related to past performance of the site is provided to the sponsor organization through self-reported information, based on information aggregated by the site. However, the site does not share the transactional data comprising this aggregate data and therefore the data is less reliable.

### SUMMARY

An illustrative computing device can receive site data from a plurality of sites. The site data can relate to a performance of each of the plurality of sites in an aspect of an activity performed by each of the plurality of sites. The computing device can determine at least one industry metric that is based at least in part on the site data. The industry metric can relate to a performance of an aspect of the activity performed by each of the plurality of sites. The computing device can send the at least one industry metric to at least one of the sites.

An illustrative computing device can receive site data from a first site. The site data can relate to a performance of the first site and be used in determining at least one industry metric. The industry metric can relate to a performance of an industry comprised of a plurality of second sites. The computing device can send the site data to a second computing device that is configured to determine the at least one industry metric. The computing device can receive the at least one industry metric from the second computing device and display the at least one industry metric on a display.

An illustrative method includes receiving site data from a site. The site data can relate to a performance of the site in an aspect of an activity. The site can be one of a plurality of sites that all operate in the same activity. The method can further include determining at least one industry metric. The industry metric can relate to a performance of the plurality of sites at the aspect of the activity. The method can also include sending the at least one industry metric to the site.

An illustrative system comprises a database that is configured to store site data of a plurality of sites. The site data can relate to a performance of each of the sites in an aspect of an activity. The plurality of sites can all operate in the activity. The system can further include a transceiver configured to receive the site data from the plurality of sites. The transceiver can also be configured to send at least one industry metric to at least one of the plurality of sites. The industry metric can be based at least in part on the site data and can relate to a performance of the plurality of sites at the aspect of the activity. The system can further include a processor that is communicatively coupled to the database and can be configured to determine the at least one industry metric.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a diagram illustrating one embodiment of a clinical trial metric system in accordance with an illustrative embodiment.

FIG. 2 is a block diagram of a central server in accordance with an illustrative embodiment.

FIG. 3 is a block diagram of a clinic computing device in accordance with an illustrative embodiment.

FIG. 4 is a flow chart illustrating one method of providing a clinical trial metric system in accordance with an illustrative embodiment.

FIG. 5 is a flow chart illustrating one method of analyzing site metrics in accordance with an illustrative embodiment.

FIG. 6 is a flow chart illustrating one method of providing metrics to a site in accordance with an illustrative embodiment.

FIG. 7 is a flow chart illustrating one method of providing metric data to a site in accordance with an illustrative embodiment.

FIG. 8 is a screenshot of a dashboard view of data in accordance with an illustrative embodiment.

FIG. 9 is a screenshot of a graphical view of data including industry metrics in accordance with an illustrative embodiment.

FIG. 10 is a screenshot of a graphical view of data including detailed information of an industry metric in accordance with an illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

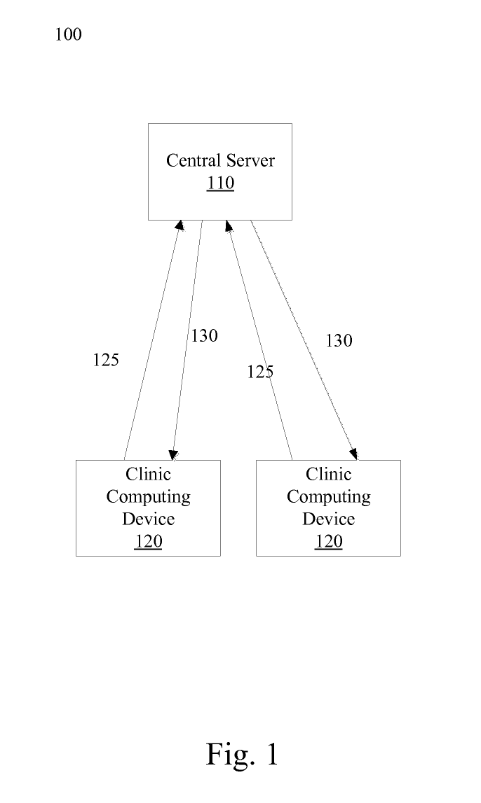

FIG. 1 is a diagram illustrating one embodiment of a clinical trial metric system 100 in accordance with an illustrative embodiment. The clinical trial metric system 100 can include a central server 110 that can send data 130 to one or more clinic computing devices 120. The central server 110 can receive data 125 from the one or more clinic computing devices 120. The data 125 and data 130 can relate to performance metrics of sites that operate the clinic computing devices 120. In an embodiment with multiple clinic computing devices 120, the various clinic computing devices 120 can each be associated with different sites. The different sites can have similar characteristics. For example, a sponsor organization may hire several clinical research sites to perform discrete functions relating to a clinical research program for a particular drug. To receive work from the sponsor organization, a site can apply to the sponsor organization for the work. Such an application can include information that can assist the sponsor organization to compare the applicant sites. For example, such applications can include estimated cost, proposed strategy, effort metrics, quality metrics, other performance indicators, and trial, site, and study conduct characteristics. The prior metrics can be provided by the site or by the sponsor organization based on past performance of work the site performed for the sponsor clinical researcher. In the case that the prior metrics are maintained by the sponsor organization based on past performance, the site may not have access to such metrics. In such a case, the site may have difficulty comparing its performance with other, similarly situated sites. Such information may be helpful for sites, especially when bidding for projects because such information can help predict a likelihood of winning a bid. Additionally, such information can assist a site in identifying aspects of its performance that fall below industry standards. The foregoing example is intended to be illustrative only, and is not meant to be limiting in any way. Although clinical research is described herein, the present disclosure is not limited to such a business, business model, or any other aspect that is specific to clinical research.

A site can refer to any entity operating in an industry. For example, a site can refer to a company, a location or office of a company, a division of a company, a project, etc. In one embodiment, a site can refer to a clinical research center working for a sponsor organization. A site can comprise one or more users that use clinic computing device 120. It should be understood that the term site is used to indicate an entity, group, organization, etc. that may have one or more persons involved. The term site can also be used in reference to the one or more persons.

For example, the sites that use clinic computing devices 120 can use the clinic computing devices 120 to maintain large amounts of data regarding day-to-day operations of the sites' business. The sites' business can be, for example, a pharmaceutical clinical trial that is sponsored by a sponsor organization. The sponsor organization can distribute discrete portions of work relating to a single project to the multiple sites that use clinic computing devices 120. The multiple sites that use the clinic computing devices 120 can send information to the central server 110, which can be operated by the sponsor organization or by another entity, to provide performance metrics. The central server 110 can aggregate the information received by the sites and provide the clinic computing devices 120 performance metrics including site-specific metrics or industry wide metrics. If both site-specific metrics and industry wide metrics are provided to a site, the site can compare the site's performance compared to the site's peers in industry.

Central server 110 can communicate to one or more clinic computing devices 120 over a communications network. The communications network can be any network or combination of networks that provides for communication between central server 110 and the one or more clinic computing devices 120, for example a local area network (LAN), a wide area network (WAN), a radio network, the Internet, a telecommunications network, or a mobile communications network. In an illustrative embodiment, central server 110 can be a single computing device such as a server. In another embodiment, central server 110 can be more than one computing device. In such an embodiment, the various computing devices can be in a single location or different locations. Similarly, in one illustrative embodiment, at least one of the one or more clinic computing devices 120 can be a single computing device. In another embodiment, at least one of the one or more clinic computing devices 120 can be more than one computing device. In such an embodiment, each of the various computing devices can be in a single location or in different locations.

Central server 110 can send data 125 to the one or more clinic computing devices 120. In an embodiment with more than one clinic computing devices 120, data 125 can be the same information sent to each clinic computing device 120. In another embodiment, data 125 can be different information sent to each clinic computing device 120. In yet another embodiment, data 125 can contain one set of information for some clinic computing devices 120 and another set of information for other clinic computing devices 120. Clinic computing device 120 can receive data 125 from central server 110.

Clinic computing device 120 can send data 130 to the central server 110. In an embodiment, data 130 can be different information sent from each clinic computing device 120. For example, data 130 can be site data relating to information used in calculating site metrics specific to the site. In yet another embodiment, data 130 can contain one set of information from some clinic computing devices 120 and another set of information from other clinic computing devices 120. Central server 110 can receive data 130 from the one or more clinic computing devices 120.

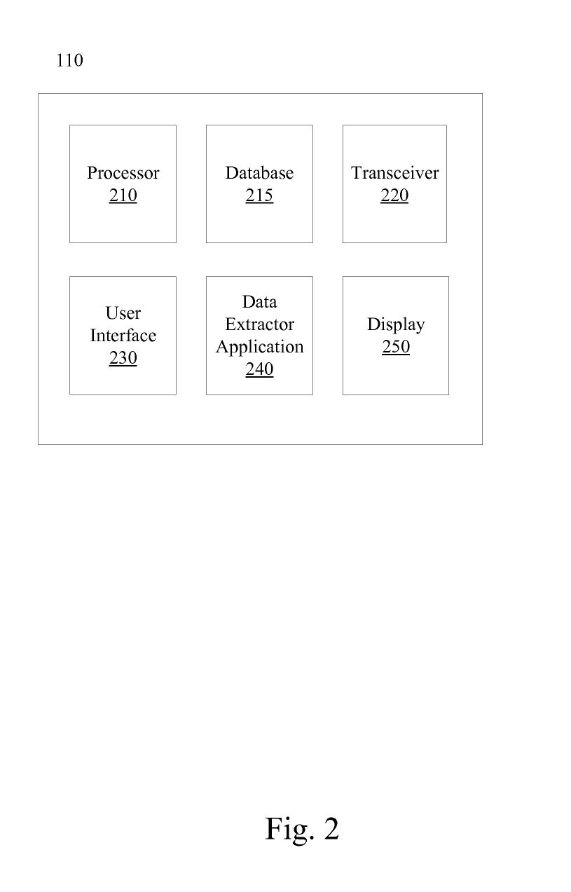

FIG. 2 is a block diagram of central server 110 in accordance with an illustrative embodiment. Central server 110 can include a processor 210, database 215, transceiver 220, user interface 230, data extractor application 240, and a display 250. In alternative embodiments, central server 110 may include additional, fewer, and/or different elements. Central server 110 can be any computing device configured to perform the functions described below, for example a personal computer (PC), a server style computing device, a network of computing devices, or a hosted computing environment.

An illustrative embodiment of central server 110 includes database 215. Database 215 can be any computer memory known to those of skill in the art. In an illustrative embodiment, database 215 can be configured to store data 125 and data 130. Processor 210 can be operatively coupled to database 215 to cause data 125 and data 130 to be stored or retrieved by central server 110. Processor 210, which can be any type of processor known to those of skill in the art, can be configured to execute computer-readable instructions stored either in database 215, or another memory associated with central server 110.

In an illustrative embodiment, transceiver 220 can be any device known to those of skill in the art that facilitates communication between central server 110 and the one or more clinic computing devices 120 over a communications network. In one embodiment, transceiver 220 can be configured to receive data 125 from clinic computing device 120 and send data 130 to clinic computing device 120. User interface 230, which can be any user interface known to those of skill in the art, can include, for example, a mouse, a touchpad, a keyboard, or a touch screen. User interface 230 can be operatively coupled to processor 210 and display 250, which can be any display known to those of skill in the art that can display information to a site, to allow a site to interact with central server 110.

In an illustrative embodiment, central server 110 can include data extractor application 240. Data extractor application 240 can be computer-readable instructions that can be executed by processor 210. In alternative embodiments, data extractor application 240 can be a device associated with central server 110 configured to perform functions described below. In such an embodiment, data extractor application 240 can be, for example, a digital signal processor, a field programmable gate array, a processor, a personal computer (PC), or a server.

In an illustrative embodiment, data extractor application 240 can be configured to receive data 125 either directly from clinic computing device 120 or from one or more components of central server 110. Data extractor application 240 can be further configured to identify certain information within data 125. For example, in an illustrative embodiment, data 125 can be sent from clinic computing device 120 in the form of a spreadsheet. The spreadsheet can include several cells wherein each cell includes some information. Some cells may include specific information used in calculating metrics, such as data points, and some cell may include other information, such as descriptions of data points, instructions to a site, graphics, text, metadata, or other information that is not used in calculating metrics. Data extractor application 240 can be configured to identify the specific information, e.g. data points. Data extractor application 240 can be further configured to store the specific information in database 215. In some embodiments, data 125 can be in other forms, as described in more detail below with regard to data input application 340 of clinic computing device 120. In those embodiments, data extractor application 240 can be configured to identify specific information and store the specific information in database 215.

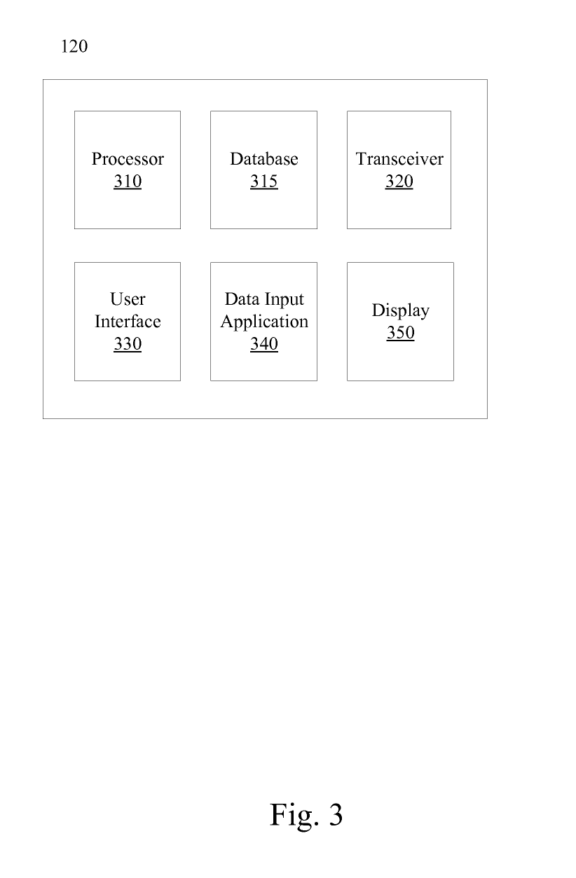

FIG. 3 is a block diagram of clinic computing device 120 in accordance with an illustrative embodiment. Clinic computing device 120 can include a processor 310, database 315, transceiver 320, user interface 330, data input application 340, and a display 350. In alternative embodiments, clinic computing device 120 may include additional, fewer, and/or different elements. Clinic computing device 120 can be any computing device configured to perform the functions described below, for example a personal computer (PC), a server style computing device, a network of computing devices, or a hosted computing environment.

An illustrative embodiment of clinic computing device 120 includes database 315. Database 315 can be any computer memory known to those of skill in the art. In an illustrative embodiment, database 315 can be configured to store data 125 and data 130. Processor 310 can be operatively coupled to database 315 to cause data 125 and data 130 to be stored or retrieved by clinic computing device 120. Processor 310, which can be any type of processor known to those of skill in the art, can be configured to execute computer-readable instructions stored either in database 315, or another memory associated with clinic computing device 120. Transceiver 320 can be any device known to those of skill in the art that facilitates communication between central server 110 and the clinic computing device 120 over a communications network. In one embodiment, transceiver 320 is configured to send data 125 to central server 110 and receive data 130 from central server 110. User interface 330, which can be any user interface known to those of skill in the art, can include, for example, a mouse, a touchpad, a keyboard, or a touch screen. User interface 330 can be operatively coupled to processor 310 and display 350, which can be any display known to those of skill in the art that can display the information to a site, to allow a site to interact with clinic computing device 120.

In an illustrative embodiment, clinic computing device 120 includes data input application 340. Data input application 340 can be computer-readable instructions that can be executed by processor 310. In alternative embodiments, data input application 340 can be a device associated with clinic computing device 120 and configured to perform functions described below. In such an embodiment, data input application 340 can be, for example, a digital signal processor, a field programmable gate array, a processor, a personal computer (PC), or a server.

In an illustrative embodiment, data input application 340 can be configured to send data 125 to central server 110. Data input application 340 can be further configured to store site data into database 215. Site data can be information relating to a site's business. For example, site data can be information used by a site to run day-to-day operations of, for example, a pharmaceutical clinical research site. Such information can include information related to clinical tests, dates of various activities, milestones, costs, or quality indicators. Dates of various activities can include historical activities or activities scheduled in the future. The various activities can be activities with a cycle time, such as reviews by an Institutional Review Board (IRB), reviews by a Protocol Review and Monitoring Committee (PRMC), contracts for work, or finalization of a budget. The cycle time can be, for example, time from submission to review and/or approval, time from approval of different stages and/or approval bodies, time from a draft contract received to full execution of a contract, time from execution of a contract to actual work on the contract has started and/or completed, or time from receipt of a draft budget and finalization of a budget. Such data can be used to calculate cycle time metrics.

In some embodiments, site data can include information relating to the size of the site's business including, for example, the number of projects, active protocols, initial reviews, or new subjects accrued during a giving time period. Such data can be used to calculate volumetric metrics. In some embodiments, site data can relate to information regarding how employees of the site are spending their time. For example, site data can include the number of hours spent on projects that are in various stages of completion. Such stages can include, for example, start up, active, follow up, and close out. Site data can also relate to tasks of employees of the site such as administration, budgeting, data management, auditing, invoicing, training, screening, monitoring, testing, or taking time off. Such data can be used to calculate effort metrics. Site metrics can include information related to a cost of particular activities related to clinical trials. For example, site data can include procedure costs for a site such as a cost of a Magnetic Resonance Imaging (MRI) procedure for a clinical trial. In some embodiments, site data can include information related to the quality of the conduct of a clinical trial. For example, site data can include the number of deviations from the window in which a subject visit should occur or the number of errors found in data completion of a case report form.

In an illustrative embodiment, site data can be received from a site, for example through user interface 330. In another embodiment, site data can be received by clinic computing device 120 from one or more other computing components that automatically generate site data. The computing components can include computer programs that help a site manage day-to-operations wherein the site data in contained in information the site inputs into such computer programs. The computer programs can supply the site data to the central server 110. In another embodiment, a separate computer program can access site data contained within a computer program a site utilizes to manage day-to-day operations.

Data input application 340 can organize site data into a format that is recognizable and readable by data extractor application 240 of central server 110. In one embodiment, data input application 340 can be a spreadsheet that includes a plurality of cells that contain information to assist a site in supplying site data in a format that is recognizable and readable by data extractor application 240. For example, a cell can contain text including “IRB Review” indicating that a site should enter, in an adjacent cell, an official Institutional Review Board review date. In such an example, when data extractor application 240 receives the spreadsheet file, the data extractor application 240 can identify the site input cell as the official Institutional Review board review date.

In another illustrative embodiment, data input application 340 can include computer-readable instructions that provide a graphical user interface for a site to input site data. In an illustrative embodiment, data input application 340 can prompt a site to input specific site data at a particular time. For example, data input application 340 can prompt a site to select a date from a graphical calendar indicating an official Institutional Review Board review date. In such an example, a site can select a date using user interface 330, and data input application 340 can read the site input, and store the date in database 315. Data input application 340 can further configure the data provided by the site to be in a format that is recognizable and readable by data extractor application 240.

In another illustrative embodiment, data input application 340 can be an application that a site utilizes for day-to-day operations. For example, a site can use a Clinical Trial Management System (CTMS) that can be used to manage large amounts of data related to operating a clinical trial. The CTMS can be integrated with other systems which are used for day-to-day operations, for example electronic health records. The CTMS can be integrated with other systems, for example electronic health records. The CTMS can also be used as data input application 340 that can be configured to provide site data to data extractor application 240 in a manner that is readable and recognizable by the data extractor application 240. Thus, the same application that a site utilizes for day-to-day operations can be used for providing site data to central server 110. Data input application 340 can be configured to provide site data to central server 110 without further site interface. Thus, providing site data to central server 110 can be performed in the background of an operating system of clinic computing device 120.

In another illustrative embodiment, central server 110 can include data input application 340. In such an embodiment, a site can use clinic computing device 120 to access data input application 340 through a communications network. In another embodiment, a site can use any communication device connected to a communications network to access the data input application 340. For example, data input application 340 can be a website available on the Internet. In such an example, a site can log in to a site account to input site data into data input application 340. The site account can be secured using any method known to those of skill in the art, for example, a username and password, a secure connection, or an encrypted connection. In another example, data input application 340 can communicate via a communications network with computing devices associated with a site that contain site information. For example, a site computing device may contain an electronic calendar, spreadsheet, database, performance tracking application, time tracking application, budget tracking application, email application, or CTMS. In such an example, data input application 340 can access site data on the site computing devices and provide the site data to data extractor application 240 in a format that is readable and recognizable by the data extractor application 240. In an illustrative embodiment, central server 110 can include data extractor application 240 and data input application 340 as a single application.

In an illustrative embodiment, data input application 340 can receive information related to a site profile. A site profile can include information indicating characteristics of a site. The site profile can include, for example, the number of employees of a site, the type of employees of a site, the number of current projects of a site, the budget of a site, etc. The site profile information can be used to compare sites with one another. In an embodiment, the site profile can be used to identify a set of sites that comprise a group such as an industry, competitors, a business area, etc. In some embodiments, site profile information can be provided to the system through means other than data input application 340.

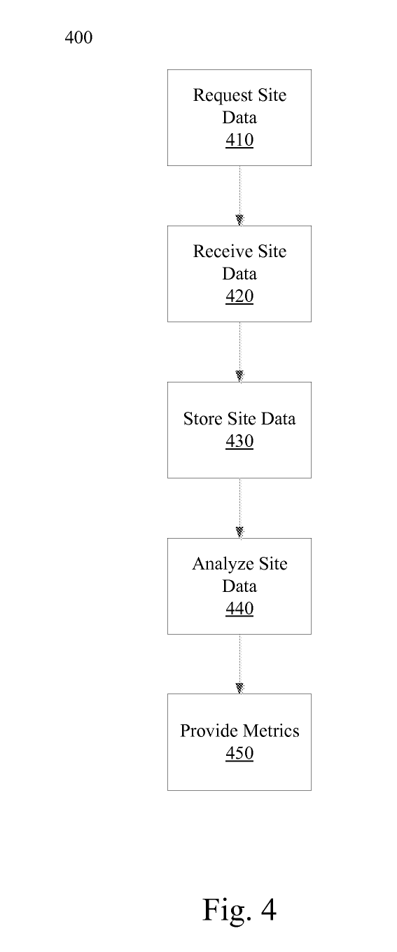

FIG. 4 is a flow chart illustrating one method of providing a clinical trial metric system in accordance with an illustrative embodiment. In alternative embodiments, fewer, additional, and/or different operations may be performed. Also, the use of a flow diagram is not meant to be limiting with respect to the order of operations performed. In an operation 410, a request for site data is sent. In an illustrative embodiment, the site data can be new site data that has not previously been received by the central server 110. In another embodiment, the site data can be an updated version of previously received site data. A request for site data can be in any form known to those of skill in the art, for example via a telecommunications network, verbal, email, letters by mail, or a digital message via the Internet. In an illustrative embodiment, central server 110 can send an electronic message to one or more clinic computing devices 120 requesting site data. A request for site data can be sent, for example, within data 130.

In an illustrative embodiment, a request for site data 410 can occur on a scheduled or regular basis, for example daily, weekly, monthly, quarterly, yearly, etc. In another embodiment, a request for site data 410 can be triggered by an event, for example the expiration of a due date. In yet another example, a request for site data 410 can occur spontaneously or in response to a site input. For example, a site user of clinic computing device 120 may wish to update the site's site data on central server 110. In such an example, a request for site data 410 can be in response to a request by the site user. In one embodiment, the site user can send site data without a request for site data from central server 110.

In an operation 420, site data is received. In one embodiment, site data is received in response to a request for site data 410. In an alternative embodiment, site data is received regardless of whether the site data is requested. In yet another embodiment, site data is received automatically, without any request for site data 410 being sent. In some embodiments, site data is sent on a scheduled basis. For example, site data can be sent daily, weekly, monthly, etc. In such an example, site data can be sent to periodically update site data received by central server 110. The site data can be sent within data 125. The site data can be received by central server 110 that can identify the site data within data 125. Central server 110 can, for example, use data extractor application 240 to identify the site data.

In an operation 430, site data can be stored. In an illustrative embodiment, central server 110 can store site data in database 215. Any storage method known to those of skill in the art can be used to store site data. In an illustrative embodiment, each discrete piece of information contained within the site data is stored in a manner that preserves the distinctiveness of each piece and is stored in a manner that identifies each piece of information. For example, a discrete piece of information may be an official Institutional Review Board review date. In such an example, site data is stored in a manner as to identifiably preserve the date including information such as the site that provided the discrete piece of information, the date the discrete piece of information was received, that the information is an official Institutional Review Board review date, or which project or trial the information is associated with.

In an operation 440, site data is analyzed. In an illustrative embodiment, site data received in operation 420 is compared and analyzed with previous site data received by the same clinic computing device 120. Site data can be analyzed to determine site metrics. In an illustrative embodiment, site metrics can be related to a particular project, trial, clinic, company, business, employee, employer, product, market, profession, group, or any other aspect that can be tracked or monitored. For example, site profile information can be correlated to the site data received. In such an example, site metrics can include metrics that track a particular employee and can provide efficiency metrics, proficiency metrics, or any other aspect that links site profile information and the site data.

In one embodiment, site data can be analyzed to determine a statistical analysis of the site data. In an illustrative embodiment, statistical analysis can include, for example, average time between milestones, average time to complete a task, average cost of a task, or the rate of change of a discrete piece of information within the site data. The term “average” is not meant to be limiting and can include, for example, mathematical mean, median, or mode. In another embodiment, statistical analysis can include a deviation of the site data received in operation 420 from similar data received from the same clinic computing device 120 or from an industry standard or average. In one embodiment, site metrics can include an historical analysis. In yet another embodiment, statistical analysis can include a prediction.

In some embodiments, operation 440 can be performed at the clinic computing device 120. In such an embodiment, clinic computing device 120 can receive site data from a site. The clinic computing device 120 can maintain and store previous site data entered by the site. The clinic computing device 120 can compute site metrics of the site and provide the metrics to central server 110. In such an embodiment, raw site data is not sent to central server 110. Rather, the clinic computing device 120 can send calculated metrics to central server 110.

In another embodiment, site data can be analyzed to determine industry metrics. In such an embodiment, site data received from a first site's clinic computing device 120 can be used with site data from multiple other sites' clinic computing devices 120. To determine industry metrics, operation 440 can include a comparison and analysis of site data from other sites' clinic computing devices 120 that are in a same or similar industry. For example, sites that use clinic computing devices 120 can be related to a general business industry like a banking industry, a medical industry, or a research industry. In another example, sites that use clinic computing devices 120 can be related to a more specific or specialized field like clinical cancer research sites, clinical pharmaceutical research sites, or clinical research sites that work on a particular drug. It will be appreciated that the term “industry metrics” can relate to metrics relating to a broad group of sites, a specific group of sites, or any combination thereof.

In yet another embodiment, site data can be analyzed to determine group metrics. In such an embodiment, site data received from a first site's clinic computing device 120 can be used with site data from multiple other sites' clinic computing devices 120. To determine group metrics, operation 440 can include a comparison and analysis of site data from other sites' clinic computing devices 120 that are in a specified group. For example, sites that use clinic computing devices 120 in the specified group can be related by a geographical region, a business type, a business within an industry, a subset of sites within an industry, etc. In one embodiment, the group can be site-defined. For example, a site may wish to compare its metrics with its competitors. In such an example, the site can specify a group consisting of the site's competitors and operation 440 can include determining metrics related to the site and its competitors.

In another embodiment, operation 440 can include determining performance benchmarks. For example, a metric can include the number of initial Institutional Review Board reviews scheduled. Such a metric can, for example, indicate the number of initial reviews during a particular time period, such as a week, a month, a calendar year, a financial year, a 7-day period, a 30-day period, etc. In such an example, operation 440 can determine a performance benchmark indicating the number of initial reviews that a site should have scheduled during that particular time period. In an illustrative embodiment, the performance benchmark can be determined based at least in part on previous performance of the site. For example, if a site consistently schedules five initial reviews a month, the performance benchmark can be five initial reviews for the next month to maintain the site's performance. Alternatively, the performance benchmark can be six or more initial reviews for the next month to increase performance of the site.

In some embodiments, performance benchmarks can be based at least in part on a cycle. In one embodiment, such a cycle can be based on a calendar, for example monthly, quarterly, or yearly. Such a calendar can be based on a fiscal year or a calendar year. For example, if an approving body historically approves few projects at the end of a fiscal year, but approves many projects at the beginning of the fiscal year, a performance benchmark for approved projects for a month immediately preceding the end of the fiscal year can be lower than a performance benchmark for approved projects for a month immediately following the beginning of a new fiscal year. In other embodiments, such a cycle can also be based on an activity such as a project. For example, a performance benchmark for the number of hours worked on a project can vary depending upon a stage of the project, an amount the project is completed, number of hours already worked on the project, etc. In another example, a performance benchmark for the number of administrative hours worked on a project can vary. In such an example, the performance benchmark can be higher at the beginning and end of a project than at the middle of the project.

In an illustrative embodiment, operation 440 can include determining a performance benchmark based at least in part on industry metrics. Using the number of initial reviews scheduled per month benchmark example discussed above, an illustrative embodiment can provide a benchmark based on the average number of initial reviews scheduled per month of a site's peers. A site's peers can be defined by the site's particular industry, including, but not limited to, other sites applying for similar work, other sites applying for work from the same employer, other sites with a similar number of employees, other sites with a similar budget, or other sites with the same or similar number of active projects or jobs. For example, a site's peers may have, on average, five initial reviews per month scheduled. In such an example, the performance benchmark can be five initial reviews per month for the site to be average within the industry. Alternatively, the performance benchmark can be six or more initial reviews for the next month to increase performance of the site compared to the site's peers.

In some embodiments, a performance benchmark can be, at least in part, site defined. In one embodiment, a site can specify a benchmark directly. For example, a site can specify that a number of approvals for a month is six approvals. In such an example, the performance benchmark can be six approvals. In another embodiment, a site can specify a performance benchmark in relation to an industry metric. Similarly, in some embodiments, a site can specify a performance benchmark in relation to site metrics. For example, a site may specify that a performance benchmark is to be 10% more than an industry average of number of hours spent on a project. Thus, if the industry average of number of hours spent on a project is 100 hours, the performance benchmark can be 110 hours.

In another illustrative embodiment, operation 440 can include determining a performance benchmark based at least in part on both site metrics and industry metrics. For example, using the initial reviews scheduled per month benchmark example above, a site can consistently schedule five initial reviews per month while the site's peers schedule, on average, ten initial reviews per month. In such an example, the performance benchmark can be between five and ten initial reviews per month. For example, the benchmark can be seven initial reviews per month. Such a benchmark may provide a graduated basis, from month to month, for the site to increase performance to meet the industry average.

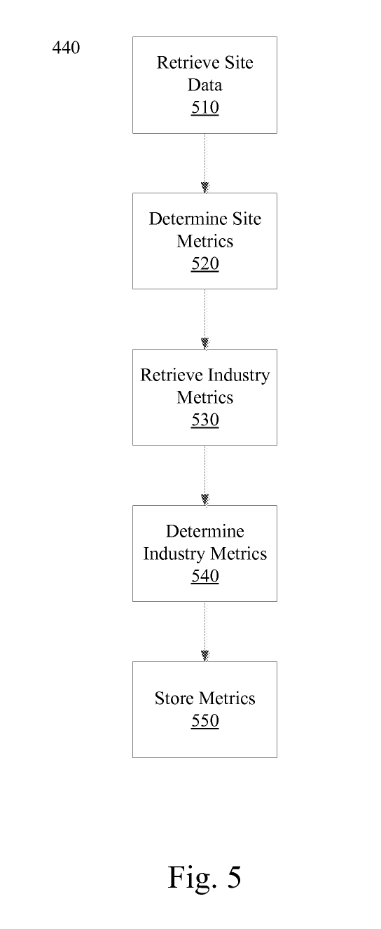

FIG. 5 is a flow chart illustrating one method of analyzing site metrics in accordance with an illustrative embodiment. In alternative embodiments, fewer, additional, and/or different operations may be performed. Also, the use of a flow diagram is not meant to be limiting with respect to the order of operations performed. In an operation 510, site data is retrieved. In one embodiment, site data can be retrieved from database 215 of central server 110. In another embodiment, site data can be retrieved from data extractor application 240. In an operation 520, site metrics are determined. Site metrics can be determined by comparing site data received in operation 420 with previously received site data. For example, site data can include a length of time to complete a task. In such an example, the site data received from a site in operation 420 can be compared to the amount of time it took the site to perform the same or similar task in the past. More specifically, for example, the comparison can result in a determination that the most recent completion of a task was shorter or longer than the site had completed a similar task in the past. The comparison can further determine a difference in time and an amount of a standard deviation from an average time. Such examples are meant to be illustrative only, and not limiting. Site metrics can be any statistical analysis or other analysis that is helpful in tracking, maintaining, or otherwise evaluating a site's performance. Once site metrics have been determined, the site metrics can be stored in a computer-readable medium.

In an operation 530, industry metrics are retrieved. In one embodiment, retrieving industry metrics includes retrieving from database 215 previously received site data. In such an embodiment, database 215 is configured to store the site metrics received from the one or more clinic computing devices 120. In an illustrative embodiment, industry metrics have been previously determined and stored in database 215 in central server 110. Thus, in operation 530, the previously determined industry metrics are retrieved from database 215. In an illustrative embodiment, processor 210 can retrieve industry metrics from database 215. In an operation 540, industry metrics are determined. In an illustrative embodiment, site data received in operation 420 is used to update or integrate into previously determined industry metrics. For example, an industry metric may include an average time to perform a task. In such an example, site data may include an amount of time it took a site in the industry to perform the task. Thus, operation 540 can include the site data into the industry data to determine a new average time to perform the task, incorporating the site data into the average. In one embodiment, data received in operation 420 can be from one or more clinic computing devices 120. In such an embodiment, industry metrics can be computed for the industry on a scheduled basis, for example daily, weekly, monthly, quarterly, yearly, etc. In an operation 550, metrics are stored. In an illustrative embodiment, site metrics and industry metrics can be stored in database 215.

Referring back to FIG. 4, in an operation 450, metrics are provided. In an illustrative embodiment, central server 110 can provide the metrics to clinic computing device 120. In one embodiment, the metrics can include site metrics for a site that uses clinic computing device 120. In another embodiment, the metrics can include industry metrics. Central server 110 can provide the metrics to clinic computing device 120 via data 130. In another embodiment, clinic computing device 120 can provide metrics to central server 110 via data 125. In such an embodiment, the metrics provided can include site metrics.

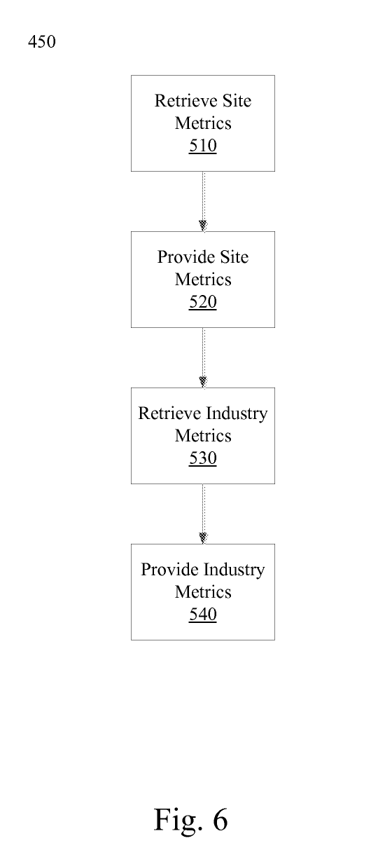

FIG. 6 is a flow chart illustrating one method of providing metrics to a site in accordance with an illustrative embodiment. In alternative embodiments, fewer, additional, and/or different operations may be performed. Also, the use of a flow diagram is not meant to be limiting with respect to the order of operations performed. In an operation 510, site metrics are retrieved. In an illustrative embodiment, site metrics can be retrieved by central server 110 from database 215. In another embodiment, site metrics can be retrieved by clinic computing device 120 from database 315. In an operation 520, site metrics can be provided. In an illustrative embodiment, site metrics can be provide by central server 110 to clinic computing device 120 via data 130. In such an embodiment, clinic computing device 120 can store the site metrics in database 315. In another embodiment, clinic computing device 120 can deliver site data to display 350. In one embodiment, site metrics can include current metrics of a site, such as a current budget, a current number of employees, a current progress of projects, etc. In another embodiment, site metrics can include past metrics of a site. In such an embodiment, site metrics can include detailed data related to past performance of the site. The site metrics can be for all metrics determined for the site from the first site metrics determined to the current metrics determined for the site. In some embodiments, only metrics associated with a range of time are provided in operation 520. Examples of a range of time include the past month, the past six months, the past six years, or from Mar. 1, 2013 to Jun. 30, 2013. In some embodiments, the site metrics provided can be related to a particular aspect of site data. For example, only site metrics related to a particular trial can be provided. In other embodiments, site metrics are provided from all trials of a site.

In an operation 530, industry metrics can be retrieved. In an illustrative embodiment, industry metrics can be retrieved by central server 110 from database 215. In another embodiment, industry metrics can be retrieved by clinic computing device 120 from database 315. In an operation 540, industry metrics are provided. In an illustrative embodiment, industry metrics can be provided by central server 110 to clinic computing device 120 via data 130. In such an embodiment, clinic computing device 120 can store the industry metrics in database 315. In another embodiment, clinic computing device 120 can deliver industry data to display 350.

In some embodiments, the method illustrated in FIG. 6 can be performed on a scheduled basis. For example, site metrics and industry metrics can be provided monthly, weekly, daily, etc. In other embodiments, site metrics and industry metrics are provided on demand or as requested by a site. In some embodiments, only site metrics are provided or only industry metrics are provided.

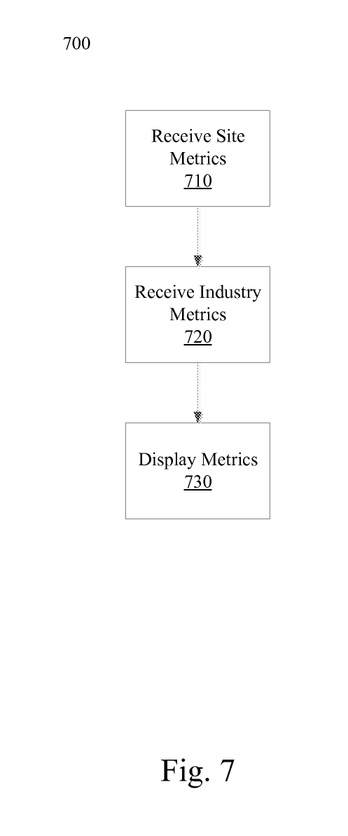

FIG. 7 is a flow chart illustrating one method of providing metric data to a site in accordance with an illustrative embodiment. In alternative embodiments, fewer, additional, and/or different operations may be performed. Also, the use of a flow diagram is not meant to be limiting with respect to the order of operations performed. In an operation 710, site metrics are retrieved. In an operation 720, industry metrics are retrieved. In an operation 730, metrics are displayed. In one embodiment, only site metrics are retrieved and displayed. In another embodiment, only industry metrics are retrieved and displayed. In yet another embodiment, both site metrics and industry metrics are retrieved and displayed. In such an embodiment, the site metrics and industry metrics can be displayed simultaneously, thereby permitting a site to easily compare site metrics with industry metrics.

In an illustrative embodiment, clinic computing device 120 can retrieve site metrics from database 315 in operation 710. Similarly, clinic computing device 120 can retrieve industry metrics from database 315 in operation 720. In another embodiment, clinic computing device 120 can retrieve metrics from central server 100 via a communications network. For example, clinic computing device 120 can be configured to access metrics by logging into a website. In such an example, metrics can be provided to clinic computing device 120 via the Internet. Further, metrics can be displayed on display 350 via an Internet browser of clinic computing device 120. In another example, clinic computing device 120 can run an application configured to access metrics. Such an application can be, for example, a hosted application (similar to a hosted desktop) wherein central server 110 can process the metrics, and provide the metrics to clinic computing device 120 for display on display 350.

Display 350 can be configured to provide a site a dashboard view of the site's site metrics and industry metrics. The dashboard view can provide a comparison of the site's site metrics with industry metrics. For example, the dashboard view can provide a graph of a site's site metric against time. The graph can further include a corresponding industry metric against time. Such a graph can provide the site with a comparison of the site's performance and the industry average on a single graph or chart. The graph can be a scatter plot, line plot, bar plot, box-and-whisker plot, etc. In the example of a box-and-whisker plot, for each time period (e.g. each month), the box-and-whisker plot can provide a site's performance, industry average, industry quartiles, industry minimum, industry maximum, or outlier data. The dashboard view can include multiple graphs wherein each graph relates to a different metric. Furthermore, the dashboard view can include groupings of graphs, wherein the groupings relate to different types of metrics such as cycle time metrics, volumetric metrics, and effort metrics.

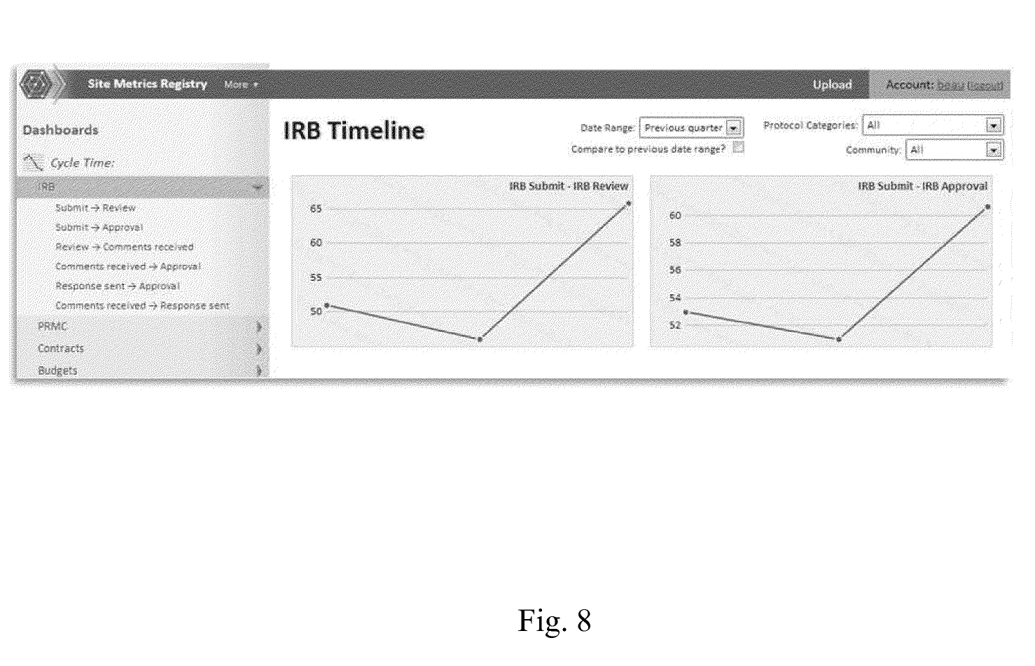

FIG. 8 is a screenshot of a dashboard view of data in accordance with an illustrative embodiment. In alternative embodiments, fewer, additional, and/or different elements may be displayed. Also, the use of a screenshot is not meant to be limiting with respect to the arrangement of elements displayed. The dashboard view can include a view selection panel. The view selection panel can be located on a left portion of display 350 and can include views related to various categories of metrics, such as cycle time metrics, volumetric metrics, or effort metrics. Each category can be associated with various high-level views of data. For example, high-level views of a cycle time category can include views associated with Institutional Review Board (IRB) metrics, Protocol Review and Monitoring Committee (PRMC) metrics, contract metrics, and budget metrics. Each high-level view can have various low-level views that can provide more detail than the high-level views. For example, low-level views of IRB metrics can include views related to the amount of time it takes from submission of a request to an IRB to review of the request, the amount of time it takes from submission of a request to an IRB to approval of the request, etc.

The dashboard view can include a graphical display of site data. For example, the display of site data can include graphical views related to the number of days it took from submission of a site's submission of a request to an IRB to review of the request over the previous three months, the number of days it took from submission of a site's request to an IRB to approval of the request over the previous three months, etc. The graphical display of site data can be modified based on user settings such as a date range, a protocol category, a community, an industry, an indication that the display is to compare the date range to the previous date range, etc.

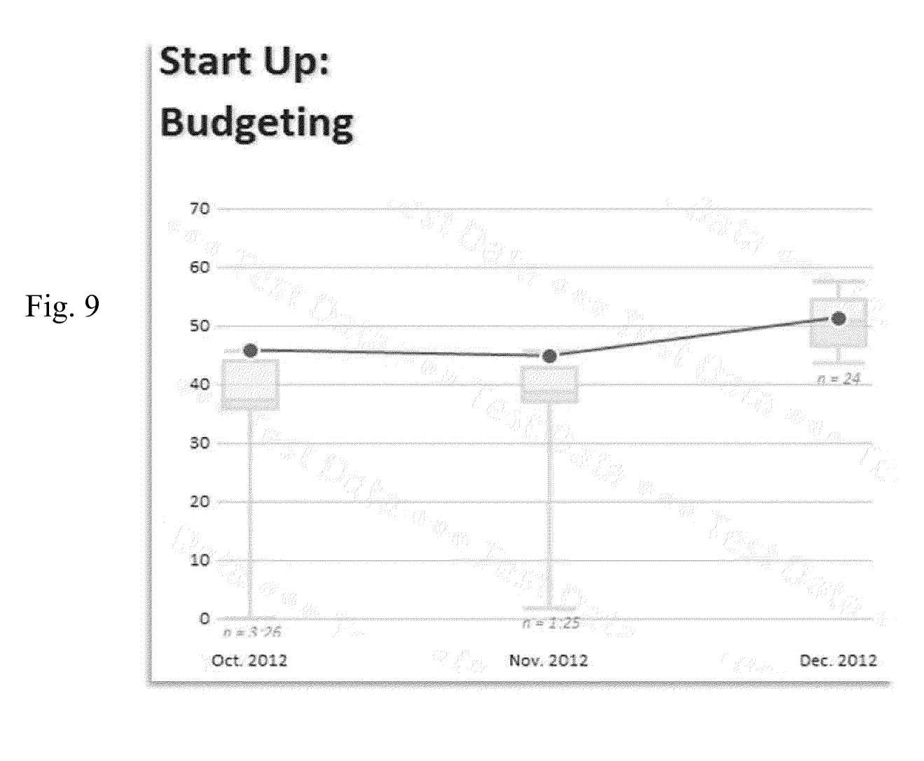

FIG. 9 is a screenshot of a graphical view of data including industry metrics in accordance with an illustrative embodiment. In alternative embodiments, fewer, additional, and/or different elements may be displayed. Also, the use of a screenshot is not meant to be limiting with respect to the arrangement of elements displayed. A graphical view of metrics can include a title indicating which metric is being displayed, for example “Start Up: Budgeting.” The graphical view can include a scale for a graph, for example from 0 units to 70 units in increments of 10 units. The graphical view can include a scale for the graph indicating a time associated with each data point or each set of data on the graph. For each increment of time, the graphical view of some embodiments can include a whisker plot of industry metrics. In some embodiments, the graphical view can include a whisker plot of site metrics. In other embodiments, no whisker plot is displayed. If a whisker plot is displayed, it can include data such as a median of the metric, a maximum value, a minimum value, a first quartile value, and a third quartile value. Some embodiments of the graphical view can include single data points indicating a site's performance. For example, a graphical view can include a whisker plot of industry metrics indicating a maximum value of 47 units. The graphical view can also include a data point indicating that the site's performance for the same time period was equivalent to the maximum value of the industry.

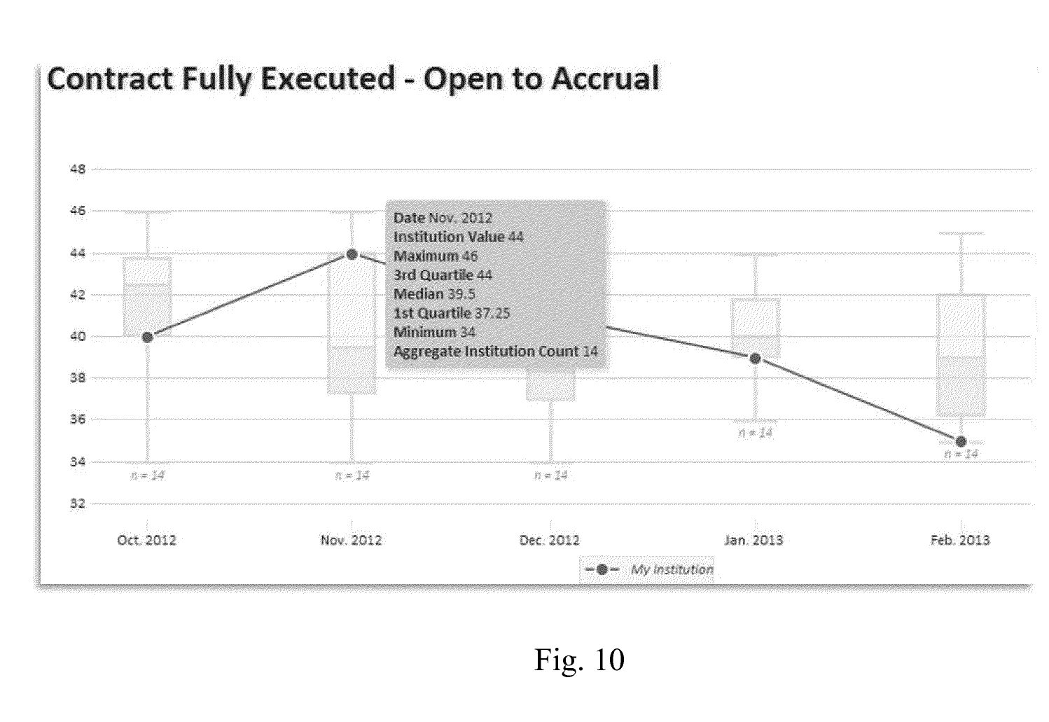

FIG. 10 is a screenshot of a graphical view of data including detailed information of an industry metric in accordance with an illustrative embodiment. In alternative embodiments, fewer, additional, and/or different elements may be displayed. Also, the use of a screenshot is not meant to be limiting with respect to the arrangement of elements displayed. The screenshot displayed in FIG. 10 includes features described in reference to FIG. 9. A graphical view can further include an indication of industry metric data of a particular time period. The industry metric data for the particular time period can be displayed in response to a user input, such as a movement of a mouse, a click of the mouse, a keyboard input, etc. The industry metric data displayed can include a data, the maximum value for that date, a minimum value, a first quartile value, a third quartile value, a median. The industry metric data displayed can further include the number of sites (or institutions) that contributed to the metric associated with that time period. The industry metric data can also include the value of the site's performance for that time period.

Any of the operations described herein can be performed by computer-readable (or computer-executable) instructions that are stored on a computer-readable medium such as database 215 or database 315. The computer-readable medium can be a computer memory, database, or other storage medium that is capable of storing such instructions. Upon execution of the computer-readable instructions by a computing device such as a user device or a venue device, the instructions can cause the computing device to perform the operations described herein.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A non-transitory computer readable medium having stored thereon instructions executable by a processor to cause the processor to perform operations comprising:
receiving site data from a plurality of sites wherein the site data relates to a performance of each of the plurality of sites in an aspect of an activity, wherein each of the sites operate in the activity;
determining at least one industry metric based at least in part on the site data, wherein the at least one industry metric relates to an average performance of multiple sites at the aspect of the activity;
generating a comparison between a performance of one site and the at least one industry metric; and
sending the generated comparison to the one site.

2. The non-transitory computer readable medium of claim 1, wherein the activity is a business.

3. The non-transitory computer readable medium of claim 1, wherein the activity is operating a pharmeceutical clinical research site.

4. The non-transitory computer readable medium of claim 1, wherein determining the at least one industry metric comprises:
retrieving, from memory, at least one previously determined industry metric related to a prior performance of the sites at the aspect of the activity, and
integrating the site data into the at least one previously determined industry metric.

5. The non-transitory computer readable medium of claim 1, wherein determining the at least one industry metric comprises averaging the site data.

6. The non-transitory computer readable medium of claim 1, wherein determining the at least one industry metric comprises:
retrieving, from memory, previous site data received from a second plurality of sites wherein the previous site data relates to a previous performance of each of the second sites relating to the aspect of the activity;
combining the previous site data and the site data to form updated site data; and
calculating the at least one industry metric based at least in part on the updated site data.

7. The non-transitory computer readable medium of claim 1, wherein the instructions further cause the processor to perform operations comprising:
determining at least one site metric based at least in part on site-specific site data wherein the site data comprises the site-specific site data, and
sending the at least one site metric to the site.

8. The non-transitory computer readable medium of claim 7, wherein determining the at least one site metric comprises:
retrieving, from memory, previous site-specific site data received from the site wherein the previous site-specific site data relates to a previous performance of the site in the aspect of the activity;
combining the previous site-specific site data and the site-specific site data to form updated site-specific site data; and
calculating the at least one site metric based at least in part on the updated site-specific site data.

9. A non-transitory computer readable medium having stored thereon instructions executable by a processor to cause the processor to perform operations comprising:
receiving site data related to a performance of a first site, wherein the site data is used in determining at least one industry metric related to an average performance of an industry comprised of a plurality of second sites;
sending the site data to a computing device configured to determine the at least one industry metric;
receiving the at least one industry metric from the computing device, wherein the received at least one industry metric relates to a performance of plurality of second sites at the aspect of the activity;
generating a comparison between a performance of the first site and the at least one industry metric; and
displaying, on a display, the generated comparision.

10. The non-transitory computer readable medium of claim 9, wherein receiving the site data comprises reading, from a memory, the site data, and
wherein the site data was stored in the memory based at least in part on second instructions executable by a second processor that cause the second processor to perform operations that manage data of the site relating to operations of a business of the site.

11. The non-transitory computer readable medium of claim 10, wherein the second instructions comprise a Clinical Trial Management System (CTMS).

12. The non-transitory computer readable medium of claim 9, wherein the site data is further used in determining at least one site metric related to a performance of the first site, and wherein the instructions further cause the processor to perform operations comprising:
receiving at least one site metric from the computing device, and
displaying, on the display, the at least one site metric.

13. The non-transitory computer readable medium of claim 12, wherein the performance of the industry and the performance of the first site relate to a same aspect of a business performance.

14. The non-transitory computer readable medium of claim 13, wherein displaying the at least one industry metric and displaying the at least one site metric comprises displaying the at least one industry metric and the at least one site metric on a graphical plot.

15. The non-transitory computer readable medium of claim 9, wherein displaying the at least one industry metric comprises displaying a median of the industry metric, a maximum value of the industry metric, a minimum value of the industry metric, a first quartile value of the industry metric, and a third quartile value of the industry metric.

16. The non-transitory computer readable medium of claim 12, wherein displaying the at least one site metric comprises displaying a median of the at least one site metric, a maximum value of the at least one site metric, a minimum value of the at least one site metric, a first quartile value of the at least one site metric, and a third quartile value of the at least one site metric.

17. A method comprising:
receiving, at a processor, site data from a first site wherein the site data relates to a performance of the first site in an aspect of an activity, wherein the first site is one of a plurality of sites that operate in the activity;
determining, by the processor, at least one industry metric based at least in part on the site data, wherein the at least one industry metric relates to an average performance of the plurality of sites at the aspect of the activity;
generating, by the processor, a comparison between a performance of the first site and the at least one industry metric; and
sending the generated comparison to the first site.

18. The method of claim 17, wherein receiving the site data comprises reading the site data from a database used by the first site to manage operations of the first site in the activity.

19. A system comprising:
a database configured to store site data of a plurality of sites wherein the site data relates to a performance of each of the plurality of sites in an aspect of an activity, wherein each of the sites operate in the activity;
a transceiver configured to receive, from the plurality of sites, the site data and send, to at least one of the plurality of sites, at least one industry metric based at least in part on the site data, wherein the at least one industrymetric relates to an average performance of the plurality of sites at the aspect of the activity; and
a processor communicatively coupled to the database configured to:
determine the at least one industry metric related to a performance of the plurality of sites at the aspect of the activity; and
generate a comparison between a performance of a first site and the at least one industry metric.

20. The system of claim 19, wherein the transeiver is further configured to receive, from the plurality of sites, raw data comprising the site data and metadata;
wherein the processor is further configured to extract the site data from the raw data; and
wherein a format of raw data received from a first site of the plurality of sites is different from a format of raw data received from a second site of the plurality of sites.

21. The system of claim 20, wherein the format of raw data received from the first site comprises a spreadsheet.

22. The system of claim 20, wherein the format of raw data received from the second site comprises a Clinical Trial Management System (CTMS).

23. The non-transitory computer readable medium of claim 1, wherein the site data is received from an automatic background computer process at the plurality of sites.

24. The non-transitory computer readable medium of claim 1, wherein the stored instructions are executable to cause the processor to automatically send the at least one industry metric to at least one of the sites.

25. The non-transitory computer readable medium of claim 1, wherein the operations further comprise identifying a set of peer sites, wherein the at least one of the sites is in the set of peer sites, and wherein the industry metric represents a combined performance of the set of peer sites at the aspect of the activity.

26. The non-transitory computer readable medium of claim 1, wherein the at least one industry metric represents a combined performance of the plurality of sites at the aspect of the activity.

27. The non-transitory computer readable medium of claim 1, wherein the received site data comprises information used by the plurality of sites to run day-to-day operations.
